(19) United States
(12) Patent Application Publication
(10) Pub. No.: US 2020/0309177 A1
(43) Pub. Date: Oct. 1, 2020

(54) STUD PIN AND CAULKING METHOD THEREOF

(71) Applicant: JVCKENWOOD Corporation, Yokohama-shi (JP)

(72) Inventors: Shun Hayashi, Yokohama-shi (JP); Kouken Murakami, Yokohama-shi (JP)

(21) Appl. No.: 16/697,489

(22) Filed: Nov. 27, 2019

(30) Foreign Application Priority Data
Mar. 25, 2019 (JP) 2019-056730

(51) Int. Cl. F16B 11/00; F16B 19/00

(52) U.S. Cl. CPC F16B 11/006; F16B 19/00

(57) ABSTRACT

A stud pin includes a first shaft part that extends in a first direction, a first flange portion that is provided coaxially with the first shaft part at one end portion of the first shaft part, a second flange portion that is larger than the first flange portion provided coaxially with the first flange portion on a side opposite to a surface of the first flange portion, on which the first shaft part is provided, and a second shaft part that is provided coaxially with the second flange portion on a side opposite to a surface of the second flange portion, on which the first flange portion is provided, and extends in a second direction opposite to the first direction.

### CROSS-REFERENCE TO RELATED APPLICATIONS

This application claims priority from Japanese Application No. 2019-056730, filed on Mar. 25, 2019, the contents of which are incorporated by reference herein in its entirety.

### BACKGROUND

### 1. Technical Field

The present disclosure relates to a stud pin and a caulking method thereof.

### 2. Description of the Related Art

A stud pin is caulked and fixed to a flat plate-shaped sheet metal and the like, and a shaft of the stud pin is used for positioning when mounting a component such as a board on the shaped sheet (Japanese Patent No. 4133813).

Usually, the stud pin has only one shaft that extends in one direction from a flange thereof. Therefore, the stud pin can be used only for positioning a component to be mounted on one surface of the sheet metal. Therefore, in order to position a component to be mounted on the other surface of the sheet metal, it is necessary to dispose two stud pins. However, when positioning components on both surfaces of the sheet metal with two stud pins, the positional accuracy of the components on both surfaces may be reduced.

The present disclosure provides a stud pin and a caulking method thereof, by which it is possible to improve the positional accuracy of components that are mounted on both surfaces of a member to be fastened.

### SUMMARY

It is an object of the present disclosure to at least partially solve the problems in the conventional technology.

A stud pin according to the present disclosure includes a first shaft part that extends in a first direction, a first flange portion that is provided coaxially with the first shaft part at one end portion of the first shaft part, a second flange portion that is larger than the first flange portion provided coaxially with the first flange portion on a side opposite to a surface of the first flange portion, on which the first shaft part is provided, and a second shaft part that is provided coaxially with the second flange portion on a side opposite to a surface of the second flange portion, on which the first flange portion is provided, and extends in a second direction opposite to the first direction.

A caulking method of a stud pin according to the present disclosure, which fixes the stud pin to a member to be fastened, the stud pin including a first shaft part that extends in a first direction, a first flange portion that is provided coaxially with the first shaft part at one end portion of the first shaft part, a second flange portion that is larger than the first flange portion provided coaxially with the first flange portion on a side opposite to a surface of the first flange portion, on which the first shaft part is provided, and a second shaft part that is provided coaxially with the second flange portion on a side opposite to a surface of the second flange portion, on which the first flange portion is provided, and extends in a second direction opposite to the first direction is disclosed. The caulking method includes an exposure step of inserting the other of the first shaft part from one side of an insertion hole provided in the member to be fastened and exposing the first shaft part and the first flange portion from the other side of the insertion hole, a support step of supporting the member to be fastened in the state in which the first shaft part and the first flange portion are exposed from the other side of the insertion hole, and a first caulking step of installing a first caulking jip on the first flange portion to accommodate the first shaft part and caulking the first flange portion with the first caulking jip.

The above and other objects, features, advantages and technical and industrial significance of this disclosure will be better understood by reading the following detailed description of presently preferred embodiments of the disclosure, when considered in connection with the accompanying drawings.

### BRIEF DESCRIPTION OF THE DRAWINGS

FIG. 1 is a schematic front view illustrating the configuration of a stud pin according to an embodiment of the present disclosure;

FIG. 2 is a schematic perspective view illustrating the configuration of the stud pin according to the embodiment of the present disclosure;

FIG. 3A is a schematic view for explaining an example of a member to be fastened;

FIG. 3B is a schematic view for explaining an example of the member to be fastened;

FIG. 4 is a schematic view for explaining an example of a caulking method according to the embodiment of the present disclosure;

FIG. 5 is a schematic view for explaining an example of a positioning method according to the present embodiment;

FIG. 6 is a schematic perspective view illustrating an example of the configuration of a first modified example of the stud pin according to the embodiment of the present disclosure;

FIG. 7A is a schematic view for explaining an example of a method of fixing the stud pin according to the first modified example to a sheet metal;

FIG. 7B is a schematic view for explaining an example of the method of fixing the stud pin according to the first modified example to the sheet metal;

FIG. 8 is a schematic perspective view illustrating an example of the configuration of a second modified example of the stud pin according to the embodiment of the present disclosure;

FIG. 9A is a schematic view for explaining an example of a method of fixing the stud pin according to the second modified example to the sheet metal;

FIG. 9B is a schematic view for explaining an example of the method of fixing the stud pin according to the second modified example to the sheet metal;

FIG. 10 is a schematic perspective view illustrating an example of the configuration of a third modified example of the stud pin according to the embodiment of the present disclosure; and

FIG. 11 is a schematic perspective view illustrating an example of the configuration of a fourth modified example of the stud pin according to the embodiment of the present disclosure.

### DETAILED DESCRIPTION

Hereinafter, with reference to the accompanying drawings, an embodiment according to the present disclosure will be described in detail. It is noted that the present disclosure is not limited by this embodiment, and when there are a plurality of embodiments, the present disclosure also includes a combination of the embodiments.

Hereinafter, an XYZ orthogonal coordinate system is set and the present disclosure will be described using the XYZ orthogonal coordinate system. It is assumed that a direction parallel to an X axis in a horizontal plane is referred to as an X direction, a direction parallel to a Y axis in a horizontal plane orthogonal to the X axis is referred to as a Y direction, and a direction parallel to a Z axis orthogonal to the horizontal plane is referred to as a Z direction. The X direction is also referred to as a right and left direction, the Y direction is also referred to as a front and rear direction, and the Z direction is also referred to as an up and down direction.

### Embodiment

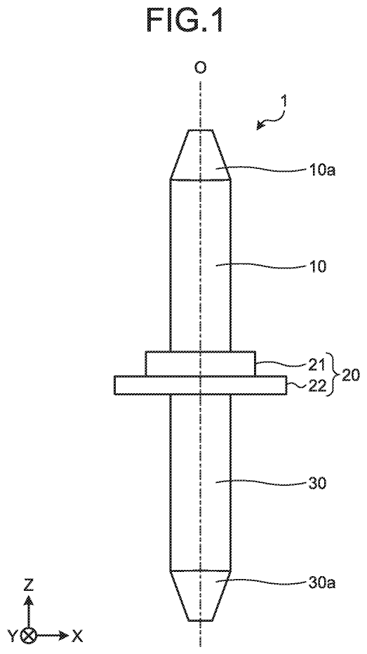

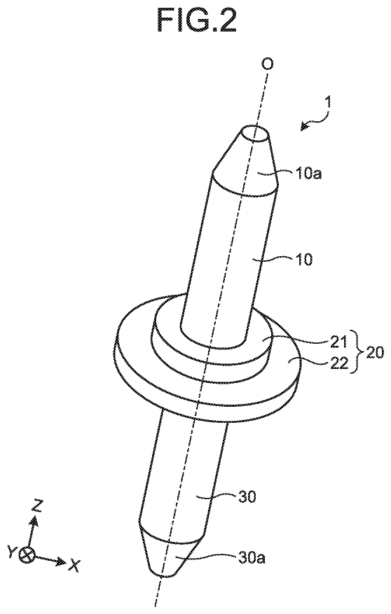

The configuration of a stud pin according to an embodiment of the present disclosure will be described using FIG. 1 and FIG. 2. FIG. 1 is a schematic front view illustrating the configuration of the stud pin according to the embodiment of the present disclosure. FIG. 2 is a schematic perspective view illustrating the configuration of the stud pin according to the embodiment of the present disclosure.

A stud pin 1 includes a first shaft part 10, a flange part 20, and a second shaft part 30. The stud pin 1 is caulked and fixed to a member to be fastened (for example, a sheet metal). The stud pin 1 is used for positioning a component (for example, a board) that is mounted on the member to be fastened.

The stud pin 1 is made of a metal, for example. The stud pin 1 may be made of resin, for example. The first shaft part 10, the flange part 20, and the second shaft part 30 are integrally formed with one another. For example, the first shaft part 10, the flange part 20, and the second shaft part 30 are integrally formed with one another using an axis O as the same central axis.

The first shaft part 10 is a shaft that extends in the +Z direction (first direction) from the flange part 20. The first shaft part 10 has a distal end portion 10a at an end portion thereof on the +Z direction side. The distal end portion 10a has a truncated cone shape that gradually becomes thinner as it goes in the +Z direction. By having the distal end portion 10a, the first shaft part 10 is easily inserted through an insertion hole formed in the member to be fastened, but may be omitted. The first shaft part 10 has a first flange portion 21 of the flange part 20 at an end portion on the −Z direction side.

The flange part 20 has the first flange portion 21 and a second flange portion 22. That is, the flange part 20 is a double flange part.

As illustrated in FIG. 2, the first flange portion 21, for example, has a columnar shape that widens on the XY plane around the axis O. A distance from the axis O to an outer edge of the first flange portion 21 is longer than a distance from the axis O to an outer edge of the first shaft part 10. The first flange portion 21 has a size that allows the first flange portion 21 to be insertable through the insertion hole provided in the member to be fastened, through which the first shaft part 10 is inserted, when the stud pin 1 is fixed to the member to be fastened. For example, the first flange portion 21 has approximately the same size as the insertion hole. The first flange portion 21 has the second flange portion 22 on the −Z direction side opposite to the surface having the first shaft part 10 on the +Z direction side. The first flange portion 21 is formed to be thicker than the thickness of the member to be fastened.

As illustrated in FIG. 2, the second flange portion 22, for example, has a columnar shape that widens on the XY plane around the axis O. A distance from the axis O to an outer edge of the second flange portion 22 is longer than the distance from the axis O to the outer edge of the first flange portion 21. That is, the second flange portion 22 is larger than the first flange portion 21. Specifically, the second flange portion 22 is formed to be larger than the insertion hole. Therefore, when the first shaft part 10 is inserted through the shaft insertion hole in order to fix the stud pin 1 to the member to be fastened, penetration beyond the above is prevented by the second flange portion 22. The second flange portion 22 has the second shaft part 30 on the −Z direction side opposite to the surface having the first flange portion 21 on the +Z direction side.

The second shaft part 30 is a shaft that extends in the −Z direction (second direction) from the flange part 20. The second shaft part 30 has a distal end portion 30a at an end portion thereof on the −Z direction side. The distal end portion 30a has a truncated cone shape that gradually becomes thinner as it goes in the −Z direction. By having the distal end portion 30a, the second shaft part 30 is easily inserted through the insertion hole, but may be omitted. That is, the second shaft part 30 has the same shape as the first shaft part 10.

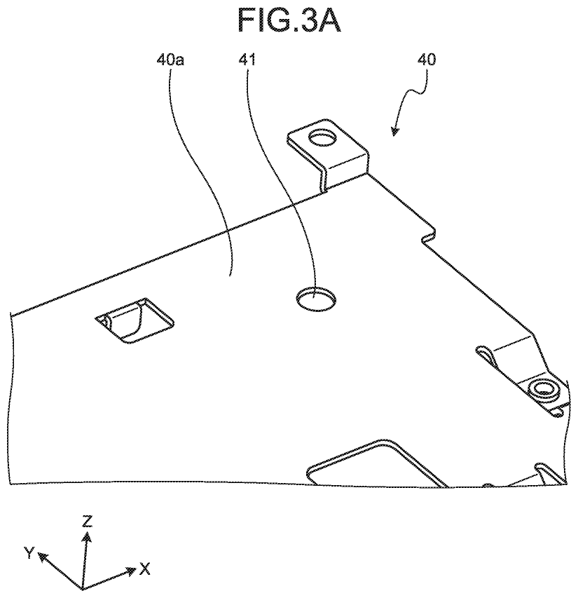

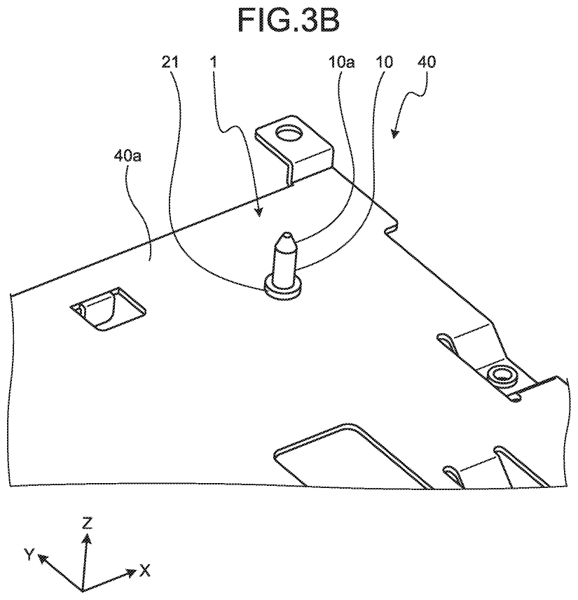

The member to be fastened according to the embodiment of the present disclosure will be described using FIG. 3A and FIG. 3B. FIG. 3A and FIG. 3B are schematic views for explaining an example of the member to be fastened according to the embodiment of the present disclosure.

As illustrated in FIG. 3A, the member to be fastened according to the present embodiment is a flat plate-shaped sheet metal 40. In the sheet metal 40, components such as boards are disposed on both a surface 40a and a back surface of the surface 40a. The sheet metal 40 has an insertion hole 41 for inserting the first shaft part 10 of the stud pin 1 thereinto.

The insertion hole 41 has a size through which the first flange portion 21, other than the second flange portion 22, can pass. Therefore, when the first shaft part 10 is inserted through the insertion hole 41, the first flange portion 21 passes through the insertion hole 41, but the second flange portion 22 does not pass through the insertion hole 41. That is, the second flange portion 22 regulates the movement of the stud pin 1 in the insertion direction with respect to the insertion hole 41.

FIG. 3B illustrates a state in which the stud pin 1 has been inserted through the insertion hole 41 of the sheet metal 40. In FIG. 3B, the first shaft part 10 of the stud pin 1 is inserted through from the back surface of the surface 40a. In this way, the first shaft part 10 and the first flange portion 21 are exposed from the surface 40a. In the present embodiment, the stud pin 1 is fixed to the sheet metal 40 by caulking the first flange portion 21 in the state illustrated in FIG. 3B.

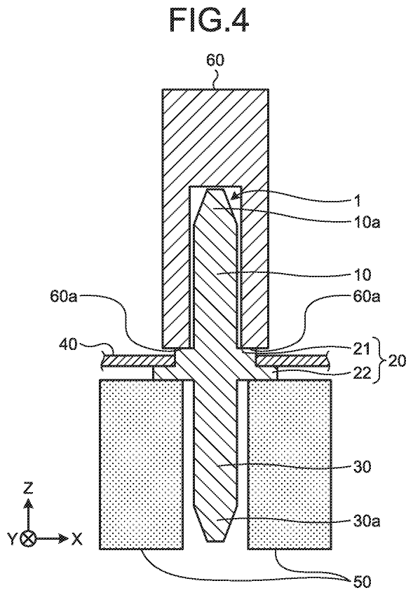

The caulking method according to the present embodiment will be described using FIG. 4. FIG. 4 is a schematic view for explaining an example of the caulking method according to the present embodiment. FIG. 4 schematically illustrates the sections of the stud pin 1, the sheet metal 40, a support jig 50, and a caulking jig 60.

The support jig 50 is a jig for maintaining the state, in which the first shaft part 10 and the first flange portion 21 have been inserted through the insertion hole 41 of the sheet metal 40, by supporting the second flange portion 22 from below.

The caulking jig 60 is a jig for fixing the stud pin 1 to the sheet metal 40 by caulking the first flange portion 21. The caulking jig 60 has a blade for caulking the first flange portion 21 at a distal end part 60a thereof. The caulking jig 60 has a space for accommodating the first shaft part 10 when caulking the first flange portion 21. A user moves the blade of the distal end part 60a in the −Z direction by hitting the caulking jig 60 from the top or presses the caulking jig 60 in the −Z direction in the state in which the blade of the distal end part 60a has been brought into contact with the first flange portion 21, so that the first flange portion 21 can be caulked. The caulking jig 60 may be a screw type in which the first flange portion 21 is caulked by moving the blade of the distal end part 60a in the −Z direction while rotating the blade of the distal end part 60a on the XY plane.

In the caulking method according to the present embodiment, the second flange portion 22 is first supported by the support jig 50 in the state in which the first shaft part 10 and the first flange portion 21 have been inserted through the insertion hole 41 of the sheet metal 40. In this way, the support jig 50 maintains the state in which the first shaft part 10 and the first flange portion 21 have been inserted through the sheet metal 40.

Next, the caulking jig 60 for caulking the first flange portion 21 is installed. Specifically, the caulking jig 60 is installed from the top of the first shaft part 10 such that the first shaft part 10 is accommodated in the space for accommodating the first shaft part 10 and the blade of the distal end part 60a and the first flange portion 21 are brought into contact with each other.

Next, the blade of the distal end part 60a of the caulking jig 60 is moved in the −Z direction to bite into the first flange portion 21, so that the first flange portion 21 is caulked. In this way, the stud pin 1 is fixed to the sheet metal 40.

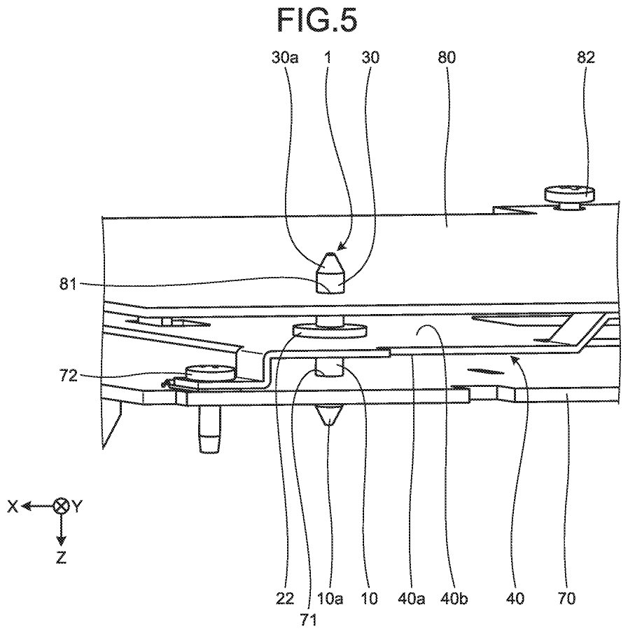

A positioning method according to the present embodiment will be described using FIG. 5. FIG. 5 is a schematic view for explaining an example of the positioning method according to the present embodiment.

FIG. 5 illustrates a state after the stud pin 1 is fixed to the sheet metal 40. The first shaft part 10 and the second shaft part 30 are used for positioning components that are mounted on the sheet metal.

The first shaft part 10 is used for positioning when a first board 70 is mounted on one surface 40a of the sheet metal 40. In such a case, the first board 70 is provided with a positioning hole 71, and when the first board 70 is mounted on the surface 40a, positioning is performed by inserting the first shaft part 10 through the positioning hole 71. In the state in which the first shaft part 10 has been inserted through the positioning hole 71, the first board 70 is mounted on the surface 40a by a screw 72 or a plurality of other screws (not illustrated).

The second shaft part 30 is used for positioning when a second board 80 is mounted on the other surface 40b of the sheet metal 40. In such a case, the second board 80 is provided with a positioning hole 81, and when the second board 80 is mounted on the surface 40b, positioning is performed by inserting the second shaft part 30 through the positioning hole 81. In the state in which the second shaft part 30 has been inserted through the positioning hole 81, the second board 80 is mounted on the surface 40b by a screw 82 or a plurality of other screws (not illustrated).

As described above, in the present embodiment, boards that are mounted on both surfaces of the sheet metal 40 can be positioned using only one stud pin 1. Therefore, the present embodiment is advantageous from the viewpoint of cost as compared with the related art.

In the present embodiment, the first shaft part 10 and the second shaft part 30 of the stud pin 1 are integrally formed with each other using the same axis O as the central axis. Therefore, positioning is performed using the stud pin 1, resulting in the improvement of positional accuracy between the first board 70 mounted on the surface 40a and the second board 80 mounted on the surface 40b.

### First Modified Example

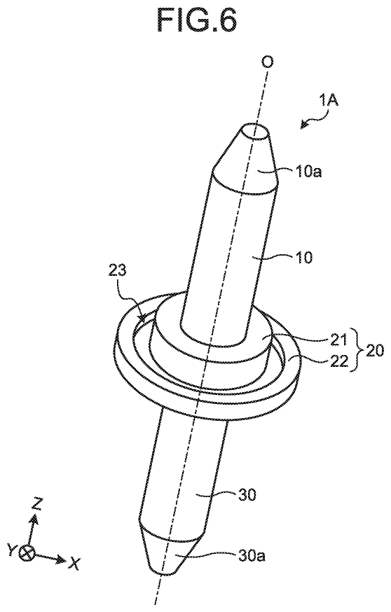

The configuration of a stud pin 1A according to a first modified example of the stud pin 1 according to the embodiment of the present disclosure will be described using FIG. 6. FIG. 6 is a schematic perspective view illustrating an example of the configuration of the stud pin 1A according to the first modified example of the stud pin 1 according to the embodiment of the present disclosure.

As illustrated in FIG. 6, the stud pin 1A is different from the stud pin 1 according to the embodiment of the present disclosure in that the second flange portion 22 has a first groove portion 23.

The first groove portion 23 is formed on the surface of the second flange portion 22 having the first flange portion 21. The first groove portion 23 is an annular groove portion formed over the entire circumference of the second flange portion 22 along the circumferential direction thereof. The first groove portion 23 is formed over the entire circumference of the second flange portion 22 along the first flange portion 21, for example. The first groove portion 23 is a groove for caulking the sheet metal 40 to fill the sheet metal 40 when the stud pin 1A is fixed to the sheet metal 40.

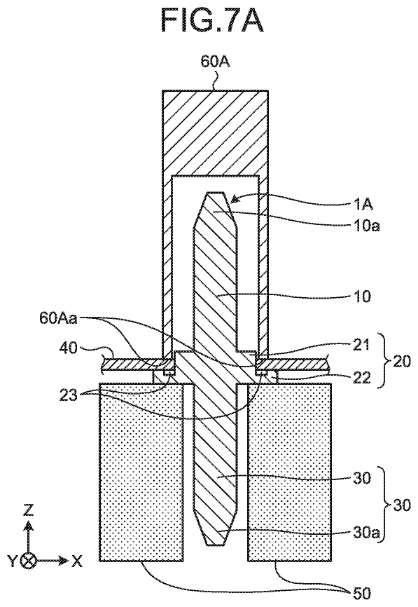

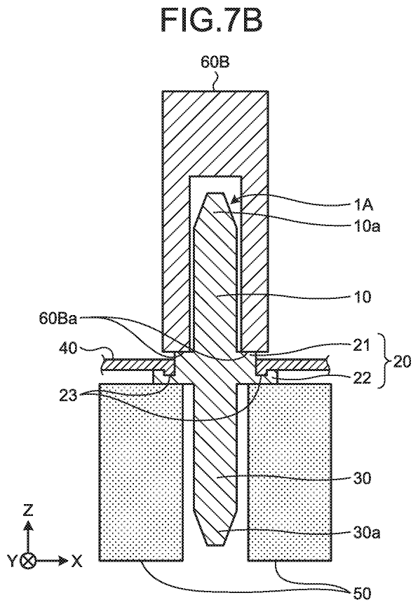

A method of fixing the stud pin 1A to the sheet metal 40 will be described using FIG. 7A and FIG. 7B. FIG. 7A and FIG. 7B are schematic views for explaining an example of the method of fixing the stud pin 1A to the sheet metal 40. FIG. 7A schematically illustrates the sections of the stud pin 1, the sheet metal 40, the support jig 50, and a caulking jig 60A. FIG. 7B schematically illustrates the sections of the stud pin 1, the sheet metal 40, the support jig 50, and a caulking jig 60B.

As illustrated in FIG. 7A and FIG. 7B, the stud pin 1A is fixed to the sheet metal 40 by using the caulking jig 60A and the caulking jig 60B.

The caulking jig 60A is a jig for caulking the sheet metal 40. The caulking jig 60A has a blade for caulking the sheet metal 40 to a distal end portion 60Aa thereof. The caulking jig 60A has a space for accommodating the first shaft part 10 when caulking the sheet metal 40. In the caulking jig 60A, since the blade of the distal end portion 60Aa is brought into contact with the sheet metal 40, the space for accommodating the first shaft part 10 is wider than the space of the caulking jig 60 according to the aforementioned embodiment. Since the method of caulking the sheet metal 40 with the caulking jig 60A is the same as the method of caulking the first flange portion 21 with the caulking jig 60 according to the aforementioned embodiment, a description thereof will be omitted.

The caulking jig 60B is a jig for caulking the first flange portion 21 after caulking the sheet metal 40 with the caulking jig 60A. The caulking jig 60B has the same configuration as that of the caulking jig 60 according to the aforementioned embodiment. Since the method of caulking the first flange portion 21 with the caulking jig 60B is the same as the method of caulking the first flange portion 21 with the caulking jig 60 according to the aforementioned embodiment, a description thereof will be omitted.

In the caulking method according to the first modified example, the second flange portion 22 is first supported by the support jig 50 in the state in which the first shaft part 10 and the first flange portion 21 have been inserted through the insertion hole 41 of the sheet metal 40, thereby maintaining the state in which the first shaft part 10 and the first flange portion 21 have been inserted through the sheet metal 40.

Next, the caulking jig 60A for caulking the sheet metal 40 is installed. Specifically, the caulking jig 60A is installed from the top of the first shaft part 10 such that the first shaft part 10 is accommodated in the space capable of accommodating the first shaft part 10 and the blade of the distal end part 60Aa and the sheet metal 40 are brought into contact with each other.

Next, the distal end part 60Aa of the caulking jig 60A is moved in the −Z direction to cause the blade to bite into the sheet metal 40, so that the sheet metal 40 is caulked. Specifically, the sheet metal 40 is caulked, so that the first groove portion 23 is filled with the sheet metal 40. Therefore, the blade of the distal end part 60Aa may be inclined toward the direction of the first groove portion 23 in order to facilitate the filling of the first groove portion 23 with the sheet metal 40.

Next, the caulking jig 60A is removed and the caulking jig 60B for caulking the first flange portion 21 is installed. Specifically, the caulking jig 60B is installed from the top of the first shaft part 10 such that the first shaft part 10 is accommodated in the space capable of accommodating the first shaft part 10 and the blade of the distal end part 60Aa and the sheet metal 40 are brought into contact with each other.

Next, the caulking jig 60B moves a distal end part 60Ba in the −Z direction and causes the blade to bite into the first flange. In this way, the stud pin 1A is fixed to the sheet metal 40.

As described above, in the first modified example, by caulking the sheet metal 40 with the caulking jig 60A, the first groove portion 23 is filled with the sheet metal 40 and then the first flange portion 21 is caulked by the caulking jig 60B, so that the stud pin 1A is fixed to the sheet metal 40. That is, in the first modified example, the stud pin 1A is fixed to the sheet metal 40 by two caulking processes. In this way, in the first modified example, the stud pin 1A is fixed to the sheet metal 40 with the first flange portion 21 and the sheet metal 40, so that it is possible to further improve fixing strength.

### Second Modified Example

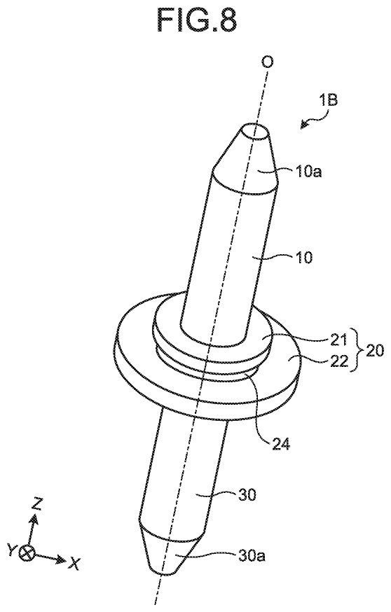

The configuration of a stud pin 1B according to a second modified example of the stud pin 1 according to the embodiment of the present disclosure will be described using FIG. 8. FIG. 8 is a schematic perspective view illustrating an example of the configuration of the stud pin 1B according to the second modified example of the stud pin 1 according to the embodiment of the present disclosure.

As illustrated in FIG. 8, the stud pin 1B is different from the stud pin 1 according to the embodiment of the present disclosure in that the first flange portion 21 has a second groove portion 24.

The second groove portion 24 is formed on a side surface of the first flange portion 21. Specifically, the second groove portion 24 is a groove portion formed over the entire circumference of the side surface of the first flange portion 21. The second groove portion 24 is formed over the entire circumference of the side surface of the first flange portion 21 along the second flange portion 22, for example. The second groove portion 24 is a groove for caulking the sheet metal 40 to fill the sheet metal 40 when the stud pin 1A is fixed to the sheet metal 40. The height of the second groove portion 24 in the Z direction is lower than the thickness of the member to be fastened.

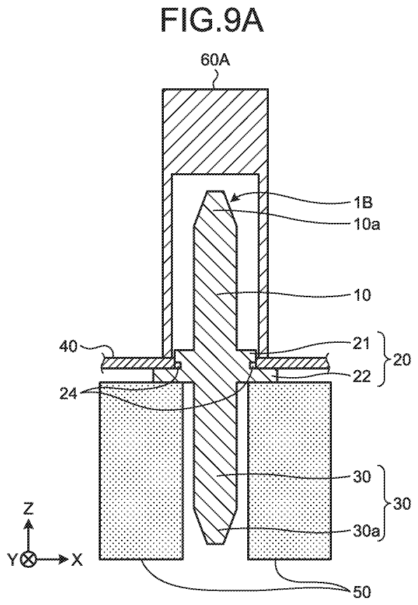

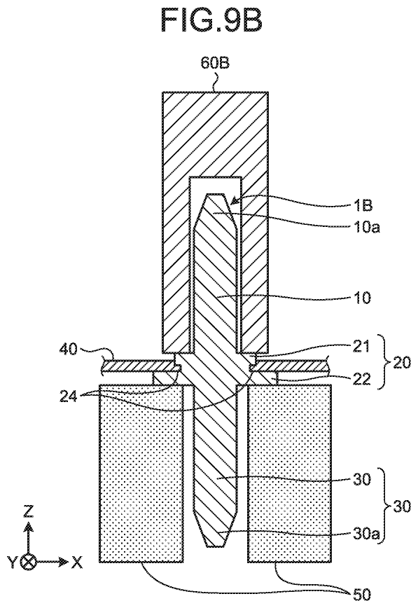

A method of fixing the stud pin 1B to the sheet metal 40 will be described using FIG. 9A and FIG. 9B. FIG. 9A and FIG. 9B are schematic views for explaining an example of the method of fixing the stud pin 1A to the sheet metal 40. FIG. 9A schematically illustrates the sections of the stud pin 1, the sheet metal 40, the support jig 50, and the caulking jig 60A. FIG. 9B schematically illustrates the sections of the stud pin 1, the sheet metal 40, the support jig 50, and the caulking jig 60B.

Since a caulking method according to the second modified example is the same as the caulking method according to the first modified example with respect to the method until the caulking jig 60A is installed after the first shaft part 10 and the first flange portion 21 are inserted through the sheet metal 40, a description thereof will be omitted.

Next, the distal end part 60Aa of the caulking jig 60A is moved in the −Z direction to cause the blade to bite into the sheet metal 40, so that the sheet metal 40 is caulked. Specifically, the sheet metal 40 is caulked, so that the second groove portion 24 is filled with the sheet metal 40. Therefore, the blade of the distal end part 60Aa may be inclined toward the second groove portion 24 in order to facilitate the filling of the second groove portion 24 with the sheet metal 40. In such a case, since the second groove portion 24 is provided on the side surface of the first flange portion 21, the direction of the blade is more parallel to the XY plane as compared with the first modified example.

Since a method of caulking the first flange portion 21 after caulking the sheet metal 40 is the same as that of the first modified example, a description thereof will be omitted.

As described above, in the second modified example, by caulking the sheet metal 40 with the caulking jig 60A, the second groove portion 24 is filled with the sheet metal 40 and then the first flange portion 21 is caulked by the caulking jig 60B, so that the stud pin 1B is fixed to the sheet metal 40. That is, in the second modified example, the stud pin 1B is fixed to the sheet metal 40 by two caulking processes. In this way, in the second modified example, the stud pin 1B is fixed to the sheet metal 40 with the first flange portion 21 and the sheet metal 40, so that it is possible to further improve fixing strength.

### Third Modified Example

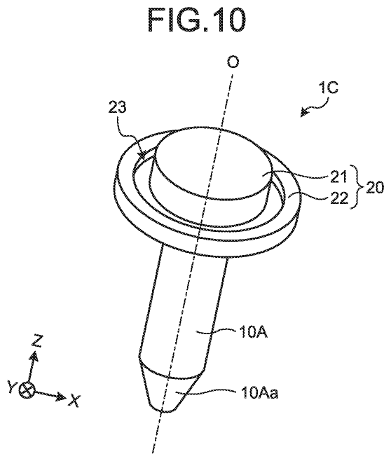

The configuration of a stud pin 1C according to a third modified example of the stud pin 1 according to the embodiment of the present disclosure will be described using FIG. 10. FIG. 10 is a schematic perspective view illustrating an example of the configuration of the stud pin 1C according to the third modified example of the stud pin 1 according to the embodiment of the present disclosure.

The stud pin 1C has a shaft part 10A and the flange part 20. The second flange portion 22 of the flange part 20 is formed with the first groove portion 23.

As in the aforementioned first modified example, when the second flange portion 22 is formed with the first groove portion 23, one shaft part may be provided. The stud pin 1C has a shape in which the first shaft part 10 of the stud pin 1A according to the first modified example is omitted. That is, the shaft part 10A corresponds to the second shaft part 30 of the stud pin 1A according to the first modified example.

The stud pin 1C can be fixed to the sheet metal 40 by the caulking method according to the first modified example described using FIG. 7A and FIG. 7B. Specifically, this method is the same as the method described in FIG. 7A and FIG. 7B, except that only the first flange portion 21 is inserted through the insertion hole 41 of the sheet metal 40 and the first shaft part 10 of the stud pin 1A is caulked while being accommodated by the caulking jig 60A and the caulking jig 60B.

The stud pin 1C according to the third modified example can be used for positioning when a component such as a board is mounted only on one surface of the sheet metal 40, for example.

### Fourth Modified Example

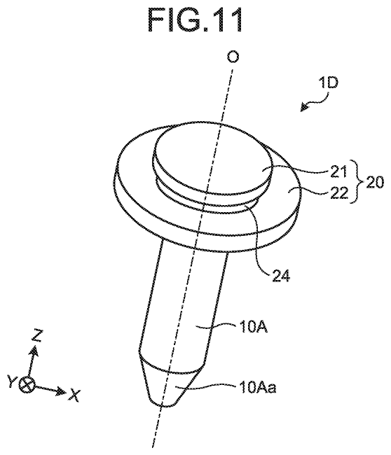

The configuration of a stud pin 1D according to a fourth modified example of the stud pin 1 according to the embodiment of the present disclosure will be described using FIG. 11. FIG. 11 is a schematic perspective view illustrating an example of the configuration of the stud pin 1D according to the fourth modified example of the stud pin 1 according to the embodiment of the present disclosure.

The stud pin 1D has the shaft part 10A and the flange part 20. The first flange portion 21 of the flange part 20 is formed with the second groove portion 24.

As in the aforementioned second modified example, when the first flange portion 21 is formed with the second groove portion 24, one shaft part may be provided. The stud pin 1D has a shape in which the first shaft part 10 of the stud pin 1B according to the second modified example is omitted.

The stud pin 1D can be fixed to the sheet metal 40 by the caulking method according to the second modified example described using FIG. 9A and FIG. 9B. Specifically, this method is the same as the method described in FIG. 9A and FIG. 9B, except that only the first flange portion 21 is inserted through the insertion hole 41 of the sheet metal 40 and the first shaft part 10 of the stud pin 1A is caulked while being accommodated by the caulking jig 60A and the caulking jig 60B.

The stud pin 1D according to the fourth modified example can be used for positioning when a component such as a board is mounted only on one surface of the sheet metal 40, for example.

The embodiment of the present disclosure has described that the first shaft part 10, the flange part 20, and the second shaft part 30 are coaxially formed using the axis O as the central axis; however, the first shaft part 10 and the second shaft part 30 may be eccentric from the axis O. In such a case, positions where the first shaft part 10 and the second shaft part 30 are eccentric may be different from each other. In this way, for example, even when there is a limitation in a position where the insertion hole 41 is provided in the sheet metal 40, the first shaft part 10 can be formed such that the first shaft part 10 can be inserted through the insertion hole 41. As a consequence, the stud pin 1 can be caulked and fixed to the sheet metal 40. The same applies to each modified example.

According to the present disclosure, it is possible to improve the positional accuracy of components that are mounted on both surfaces of a member to be fastened.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A stud pin comprising:
a first shaft part that extends in a first direction;
a first flange portion that is provided coaxially with the first shaft part at one end portion of the first shaft part;
a second flange portion that is larger than the first flange portion provided coaxially with the first flange portion on a side opposite to a surface of the first flange portion, on which the first shaft part is provided; and
a second shaft part that is provided coaxially with the second flange portion on a side opposite to a surface of the second flange portion, on which the first flange portion is provided, and extends in a second direction opposite to the first direction.

2. The stud pin according to claim 1, wherein the first flange portion has a size that allows the first flange portion to be insertable through an insertion hole of a member to be fastened through which the first shaft part is inserted from the other end portion thereof, and
the second flange portion has a shape larger than the hole of the member to be fastened.

3. The stud pin according to claim 1, wherein the second flange portion has a first groove portion formed along a circumferential direction on the surface on which the first flange portion is provided.

4. The stud pin according to claim 1, wherein the first flange portion has a second groove portion formed along a circumferential direction of a side surface thereof.

5. A caulking method of a stud pin, which fixes the stud pin to a member to be fastened, the stud pin including a first shaft part that extends in a first direction, a first flange portion that is provided coaxially with the first shaft part at one end portion of the first shaft part, a second flange portion that is larger than the first flange portion provided coaxially with the first flange portion on a side opposite to a surface of the first flange portion, on which the first shaft part is provided, and a second shaft part that is provided coaxially with the second flange portion on a side opposite to a surface of the second flange portion, on which the first flange portion is provided, and extends in a second direction opposite to the first direction, the caulking method comprising:
an exposure step of inserting the other of the first shaft part from one side of an insertion hole provided in the member to be fastened and exposing the first shaft part and the first flange portion from the other side of the insertion hole;
a support step of supporting the member to be fastened in the state in which the first shaft part and the first flange portion are exposed from the other side of the insertion hole; and
a first caulking step of installing a first caulking jip on the first flange portion to accommodate the first shaft part and caulking the first flange portion with the first caulking jip.

6. The caulking method according to claim 5, wherein the second flange portion has a first groove portion formed along a circumferential direction on the surface on which the first flange portion is provided, and
the caulking method comprises, between the support step and the first caulking step:
a second caulking step of setting a second caulking jip on a sheet metal to accommodate the first shaft part, caulking the sheet metal with the second caulking jip, and filling the first groove portion with the sheet metal.

7. The caulking method according to claim 5, wherein the first flange portion has a second groove portion formed along a circumferential direction of a side surface thereof, and
the caulking method comprises, between the support step and the first caulking step:
a second caulking step of setting a second caulking jip on a sheet metal to accommodate the first shaft part, caulking the sheet metal with the second caulking jip, and filling the second groove portion with the sheet metal.
